(19) United States
(12) Patent Application Publication
(10) Pub. No.: US 2014/0098559 A1
(43) Pub. Date: Apr. 10, 2014

(54) Luminous Decoration Assembly For Automobile

(71) Applicant: Hon Yu Auto Parts Co., Ltd., New Taipei City (TW)

(72) Inventor: Yin-Teng HSIAO, New Taipei City (TW)

(73) Assignee: Hon Yu Auto Parts Co., Ltd., New Taipei City (TW)

(21) Appl. No.: 14/013,563

(22) Filed: Aug. 29, 2013

(30) Foreign Application Priority Data
Oct. 4, 2012 (TW) TW101219153

(51) Int. Cl. F21V 8/00; F21S 8/10

(52) U.S. Cl. CPC G02B 6/0096; F21S 48/30
USPC 362/555; 362/559; 362/560

(57) ABSTRACT

A luminous decoration assembly for automobile contains a decorating member, a stripped light shell, a flexible guiding strap, and at least one light-emitting element. The stripped light shell is connected with the decorating member. The flexible guiding strap is retained in the stripped light shell. The at least one light-emitting element is disposed on one end of the flexible guiding strap so as to project light to one end of the flexible guiding strap, and the light from the flexible guiding strap emits to the stripped light shell.

### FIELD OF THE INVENTION

The present invention relates to a luminous decoration assembly for automobile in which a flexible guiding strap conducts light so as to obtain decoration effect further.

### BACKGROUND OF THE INVENTION

A conventional luminous decoration assembly for automobile contains at least one bulb or LED to emit light by using a single light source or plural light sources.

However, when using the plural light sources, the brightness of the linear light source is usually not harmonious. Especially, when the plural light sources are comprised of light straps, the brightness is produced more inharmonious.

The present invention has arisen to mitigate and/or obviate the afore-described defects.

### SUMMARY OF THE INVENTION

The primary objective of the present invention is to provide a luminous decoration assembly for automobile in which a flexible guiding strap conducts light so as to obtain decoration effect further.

To obtain the above objective, a luminous decoration assembly for automobile provided by the present invention contains: a decorating member, a stripped light shell, a flexible guiding strap, and at least one light-emitting element. The stripped light shell is connected with the decorating member. The flexible guiding strap is retained in the stripped light shell. The at least one light-emitting element is disposed on one end of the flexible guiding strap so as to project light to one end of the flexible guiding strap, and cause the flexible guiding strap to emit light to the stripped light shell.

Preferably, the decorating member includes a stripped groove defined thereon so as to retain with the stripped light shell.

Preferably, the stripped light shell includes an extending portion to be coupled with the decorating member.

Preferably, the extending portion adheres with the decorating member by ways of at least one adhesive piece.

Preferably, the stripped light shell also includes a stripped slot to be embedded with the flexible guiding strap.

Preferably, the stripped light shell is provided with a plurality of light diffusion textures.

Preferably, the stripped light shell further includes a light reflecting sheet.

Preferably, the at least one light-emitting element are disposed on two ends of the flexible guiding strap so as to project the light to the one end of the flexible guiding strap.

Preferably, the flexible guiding strap further includes a fitting sleeve disposed on the one end of the flexible guiding strap.

Preferably, the at least one light-emitting element is either a light-emitting diodes (LED) or a bulb.

### BRIEF DESCRIPTION OF THE DRAWINGS

FIG. 1 is a front plan view showing the assembly of a luminous decoration assembly for automobile according to a preferred embodiment of the present invention.

FIG. 2 is a cross sectional view showing the assembly and operation of a luminous decoration assembly for automobile according to a preferred embodiment of the present invention.

### DETAILED DESCRIPTION OF THE PREFERRED EMBODIMENTS

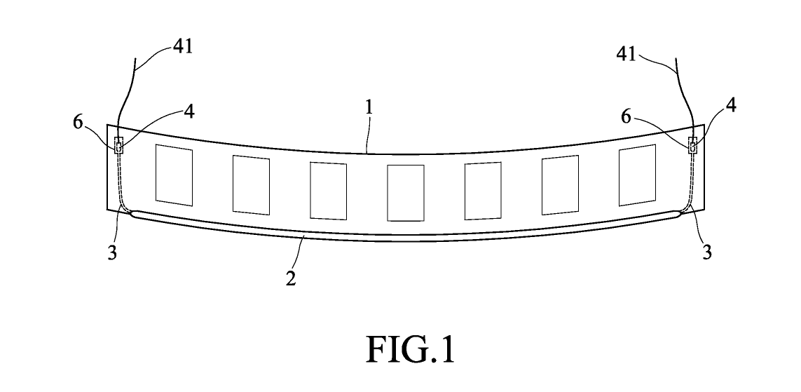

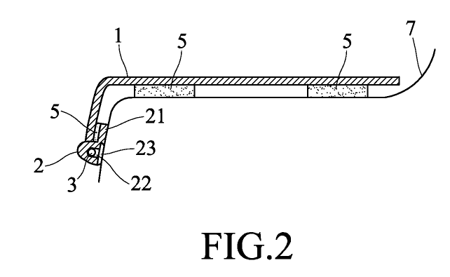

With reference to FIGS. 1 and 2, a luminous decoration assembly for automobile according to a first embodiment of the present invention comprises: a decorating member 1 fixed on an automobile, a stripped light shell 2 connected with and exposing outsides the decorating member 1, a flexible guiding strap 3 used to guide light and retained in the stripped light shell 2, and at least one light-emitting element 4 disposed on one or two ends of the flexible guiding strap 3 so as to project the light to an edge of the flexible guiding strap 3, and cause the flexible guiding strap 3 to emit light to the stripped light shell 2, thus producing gently stripped light. The decorating member 1 also includes at least one side rim, at least one side pedal trim, and at least one front and rear side trim. The decorating member 1 includes a stripped groove 11 defined thereon so as to retain with the stripped light shell 2.

As shown in FIG. 2, the stripped light shell 2 includes an extending portion 21 coupled with the decorating member 1, and the extending portion 21 adheres with the decorating member 1 by ways of at least one adhesive piece 5 so that the stripped light shell 2 is fixed on the decorating member 1. Also, the stripped light shell 2 can be screwed with the decorating member 1.

The stripped light shell 2 also includes a stripped slot 22 for engaging with the flexible guiding strap 3, such that the flexible guiding strap 3 is received in the stripped light shell 2. In addition, the flexible guiding strap 3 is bent so as to match with a path of the stripped slot 22.

The at least one light-emitting element 4 is either a light-emitting diodes (LED) or a bulb, the flexible guiding strap 3 includes one light-emitting element 4 mounted on one end thereof so as to project the light to the flexible guiding strap 3, and cause the flexible guiding strap 3 to emit light to the stripped light shell 2, thereby producing a gently stripped light.

Likewise, the flexible guiding strap 3 also includes two ends on which two light-emitting elements 4 are mounted, such that lights from the two light-emitting elements 4 project to one end of the flexible guiding strap 3, and cause the flexible guiding strap 3 to emit light to the stripped light shell 2, thereby producing gently brighter lights.

As illustrated in FIG. 1, the flexible guiding strap 3 further includes a fitting sleeve 6 disposed on the edge of the flexible guiding strap 3, and the at least one light-emitting element 4 is mounted in the fitting sleeve 6 so that the at least one light-emitting element 4 is further fixed in the edge of the flexible guiding strap 3 and emits light to the flexible guiding strap 3.

The at least one light-emitting element 4 is connected with a power supply unit through a wire 41, and the power supply unit is any one of a battery and a solar panel.

Accordingly, the decorating member 1 of the luminous decoration assembly of the present invention is fixed on an outer surface of the automobile 7, and the stripped light shell 2 is connected with the decorating member 1, the flexible guiding strap 3 is retained in the stripped light shell 2, and the at least one light-emitting element 4 is disposed on one or two ends of the flexible guiding strap 3, such that light projects to the edge of the flexible guiding strap 3, and cause the flexible guiding strap 3 to emit light to the stripped light shell 2, thereby producing gently stripped light.

To emit the light out of the stripped light shell 2 softly, the stripped light shell 2 are provided with a plurality of light diffusion textures. To increase brightness, the stripped light shell 2 further includes a light reflecting sheet 23.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A luminous decoration assembly for automobile comprising:
a decorating member;
a stripped light shell connected with the decorating member;
a flexible guiding strap retained in the stripped light shell; and
at least one light-emitting element disposed on one end of the flexible guiding strap so as to project light to the one end of the flexible guiding strap, and cause the flexible guiding strap to emit light to the stripped light shell.

2. The luminous decoration assembly for the automobile as claimed in claim 1, wherein the decorating member includes a stripped groove defined thereon so as to retain with the stripped light shell.

3. The luminous decoration assembly for the automobile as claimed in claim 1, wherein the stripped light shell includes an extending portion coupled with the decorating member.

4. The luminous decoration assembly for the automobile as claimed in claim 3, wherein the extending portion adheres with the decorating member by ways of at least one adhesive piece.

5. The luminous decoration assembly for the automobile as claimed in claim 1, wherein the stripped light shell also includes a stripped slot for engaging with the flexible guiding strap.

6. The luminous decoration assembly for the automobile as claimed in claim 1, wherein the stripped light shell are provided with a plurality of light diffusion lines.

7. The luminous decoration assembly for the automobile as claimed in claim 1, wherein the stripped light shell further includes a light reflecting sheet.

8. The luminous decoration assembly for the automobile as claimed in claim 1, wherein the at least one light-emitting element are disposed on two ends of the flexible guiding strap so as to project the light to the one end of the flexible guiding strap.

9. The luminous decoration assembly for the automobile as claimed in claim 1, wherein the flexible guiding strap further includes a fitting sleeve disposed on the one end of the flexible guiding strap.

10. The luminous decoration assembly for the automobile as claimed in claim 8, wherein the flexible guiding strap further includes a fitting sleeve disposed on the one end of the flexible guiding strap.

11. The luminous decoration assembly for the automobile as claimed in claim 1, wherein the at least one light-emitting element is either a light-emitting diodes (LED) or a bulb.
